(19) United States
(12) Patent Application Publication
(10) Pub. No.: US 2010/0095873 A1
(43) Pub. Date: Apr. 22, 2010

(54) Method for pretreating charges contaminated with carbon carriers

(75) Inventors: Jorge Guillermo Franco Zesati, Colima (MX); Francisco Salas Vallejo, Colima (MX); Armando Alberto Cruz Arellano, Colima (MX); Beat Stoffel, Zumikon (CH)

Correspondence Address: CHAPMAN AND CUTLER, 111 WEST MONROE STREET, CHICAGO, IL, 60603, US

(73) Assignee: HOLCIM TECHNOLOGY LTD., JONA (CH)

(21) Appl. No.: 12/310,895

(22) PCT Filed: Sep. 7, 2007
(86) PCT No.: PCT/IB2007/002574

§ 371 Date: Oct. 6, 2009

(30) Foreign Application Priority Data
Sep. 14, 2006 (AT) A 1533/2006

(51) Int. Cl. C04B 7/38; C04B 2/10

(52) U.S. Cl. 106/771

(57) ABSTRACT

In a method for pretreating charges contaminated with carbon carriers such as, for instance, carbon-carrier-contaminated earths, soils, rocks or minerals having low calorific values for use in clinker kilns, the mentioned charges are introduced into a reactor (8) and heated or dried with gases. The heated gases are drawn off at temperatures below 1250° C., preferably between 700 and 900° C., and the heated or dried charge is separately discharged at temperatures between 500° C. and 1000° C., wherein the temperatures are set and maintained to stabilize the temperature distribution within the reactor (8) by controlling the supply of fresh air, the supply of water or water vapour, by controlling the feed rate of the charge and/or of process gases such as, e.g., tertiary air as well as, if required, by burning fuels. The gases drawn off from the reactor (8) are at least partially recirculated into the reactor (8) and/or supplied to a precalcining stage and/or a preheating stage of the clinker kiln (1).

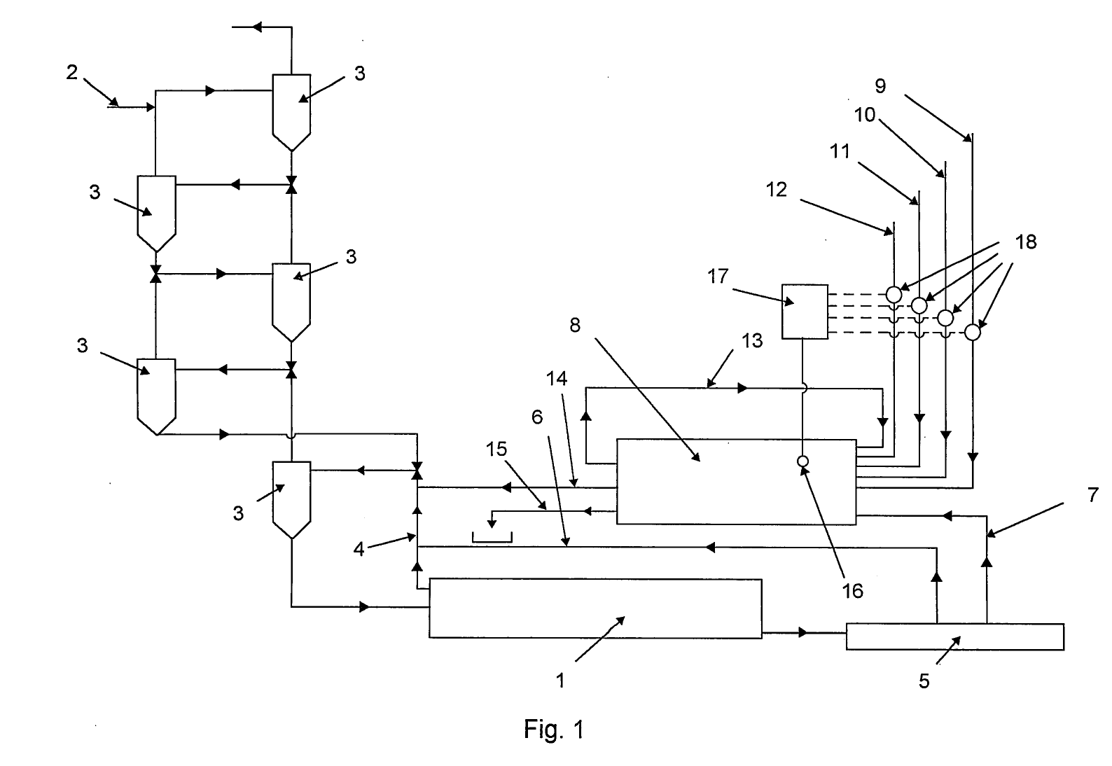

The present invention relates to a method for pretreating charges contaminated with carbon carriers for use in clinker kilns.

In the production of cement clinker from cement raw meal, it is known to use cyclone floating gas heat exchanger systems as raw meal preheaters. Such heat exchanger systems are usually fed with fuel and tertiary air from clinker coolers. Following preheating and/or calcining, sintering will take place in a rotary tubular kiln with clinker being discharged.

For the use of secondary fuels having low caloric values, it is known to charge the same either directly into the rotary tubular kiln for clinker production or to carbonize at low temperatures, or gasify, the same in a separate reactor. When using separate reactors, the fact that alternative fuels having relatively low heating values will usually require extended residence times for more or less complete reactions can be taken into account. To this end, a calcining device operated as an auxiliary reactor has become known from EP-A 764 614, which calcining device, in the manner of a shaft gasifier, is charged with lumpy waste substances and, in particular, used tires as fuels. The product gas forming in such a shaft gasifier was then conducted into the calciner as a combustion gas, with the residual substances of the used tires gasified in the shaft gasifier having been conveyed through a mechanical ejection device into the rotary kiln entry shaft.

From DE-C 35 33 775, an installation for the production of cement clinker from raw meal using heating-value-containing waste substances has become known, in which those alternative fuels after drying are introduced into a carbonization furnace for pyrolysis or partial combustion of the waste substances, which furnace is operated by the exhaust gas from the rotary kiln and a partial stream of tertiary air. In that process, the pyrolysis gas is introduced into the calciner.

EP 1 334 954 A1 shows and describes a further development of that installation, in which the exploitation of heating-value-containing waste substances in a separate rotary kiln is utilized to preheat cement raw meal in that separate reactor. Also there, it was recognized that the low-temperature carbonization or combustion of waste substances and, in particular, also lumpy waste substances in a rotary tubular kiln does by no means ensure that uniform thermal treatment conditions will be created and, in particular, the occurrence of temperature peaks will be prevented, which will lead to undesired solids caking in the rotary tubular kiln.

The invention now aims to provide a method of the initially defined kind, by which even the processing of, for instance, oil-contaminated soils, earths, rocks, minerals and/or charges with low calorific values for use in clinker kilns is feasible in a suitable manner by using known devices with merely simple modifications of such devices. The contaminated soils and earths exploited in the vicinity of oil drilling fields, in particular, constitute problems which have not been solved in a suitable manner by the known methods.

To solve this object, the method according to the invention is essentially characterized in that the charges are introduced into a reactor and heated or dried with gases, that the heated gases are drawn off at temperatures below 1250° C., preferably between 700 and 900° C., and the heated or dried charge is separately discharged at temperatures between 500° C. and 1000° C., wherein the temperatures are set and maintained to stabilize the temperature distribution within the reactor by controlling the supply of fresh air, the supply of water or water vapour, by controlling the feed rate of the charge and/or of process gases such as, e.g., tertiary air as well as, if required, by burning fuels, and that the gases drawn off from the reactor are at least partially recirculated into the reactor and/or supplied to a precalcining stage and/or a preheating stage of the clinker kiln. While heating and drying are effected in a largely conventional manner, the essential advantage of the method according to the invention resides in that the temperatures are now influenced by a substantially more comprehensive control in order to take into account the most diverse charging substances and, in particular, charges contaminated with carbon carriers. In doing so, it is essential for the method according to the invention that the control of the temperatures is not only effected by controlling the supply of fresh air and/or by controlling the feed rate of the charge and/or of process gases such as, e.g., tertiary air, but that, above all, the option of introducing water or water vapour into the reactor is provided in addition. Such a device also renders feasible the disposal of contaminated waters while, at the same time, allowing the reformation of gases in the interior of the reactor so as to directly obtain high-quality fuel gases. The reaction of carbon carriers with water vapour at accordingly high temperatures will, in fact, directly result in reformed gas such that starting products having low heating values will yield high-quality fuel gases. For the use of the most diverse materials it is, however, not essential that a specific reaction or a specific reaction degree will be achieved, but that a defined temperature control safely avoiding the formation of cakings due to temperature peaks will be observed. This will be achieved by the comprehensive control proposed by the method according to the invention, wherein, if required, the combustion of fuels is additionally effected to the extent necessary to stabilize the temperature distribution within the reactor.

The method according to the invention is advantageously performed in a manner that the control of the temperatures is effected with water by using contaminated and, in particular, oil- and/or hydrocarbon-contaminated water.

As with known devices, it may be proceeded according to the invention in a manner that the charge in the reactor is mechanically moved and, in particular, circulated by rotation of the reactor, said charge preferably comprising earths, soils, rocks or minerals contaminated with carbon carriers and having low calorific values.

In the main, the temperature level in the additional reactor, in which the carbon-carrier-contaminated charges are pretreated, can be kept relatively low, since combustion is not the point. For combustion, the calorific value of the contaminated charges will, as a rule, be too low. What actually matters according to the invention is that the temperature be kept sufficiently low to safely avoid cakings and temperature peaks by local combustions.

The method according to the invention advantageously is performed such that the charge is discharged at temperatures of about 800° C.

In the following, the invention will be explained in more detail by way of an exemplary embodiment schematically illustrated in the drawing, of a device suitable for carrying out the method according to the invention.

In the drawing, a rotary tubular kiln for the production of clinker is denoted by 1, into which raw meal is charged through duct 2. The raw meal is preheated or calcined in a floating gas heat exchanger including cyclones 3, the heating gases of the clinker kiln being supplied to said floating gas heat exchanger via duct 4.

The clinker leaving the rotary tubular kiln 1 reaches a clinker cooler 5. The tertiary air drawn off from the clinker cooler 5, via a first duct 6, is returned to the preheating or precalcining stage and, hence, to the floating gas heat exchanger (cyclone 3), whereby a partial amount is fed to a further rotary-drum-type reactor 8 via duct 7. This further rotary-drum-type reactor 8 is equipped with a comprehensive number of charging means allowing fresh air to be supplied via duct 9, water or water vapour via duct 10, a carbon-carrier-contaminated charge via duct 11 and, optionally, additional fuel via duct 12 to stabilize the temperature distribution within the reactor 8. The hot process gases can be recirculated via the ring duct 13, where only a partial amount is being recirculated and excess hot gases can be drawn off and fed to the floating-gas heat exchangers via duct 14. Duct 15 finally serves to discharge the pretreated charges.

By appropriately monitoring the temperatures in the interior of the rotary-drum-type reactor 8 by the aid of schematically indicated temperature sensors 16 whose signals are supplied to a processor 17, the individual feed rates in the charging ducts 9, 10, 11 and 12 can be controlled in the required manner via suitable control members denoted by 18.

1-5. (canceled)

6. A method for pretreating charges of alternative fuels contaminated with carbon carriers for use in clinker kilns, comprising the steps of:
introducing said charges of alternative fuels into a reactor;
heating or drying the charges of alternative fuels with gases;
drawing off the gases at temperatures below 1250° C.; and
separately discharging the heated or dried charges of alternative fuels at temperatures between 500° C. and 1000° C.,
wherein
temperatures are set and maintained to stabilize a temperature distribution within the reactor (8) by one or more of:
(a) controlling supply of fresh air, supply of water, and supply of water vapour;
(b) controlling a feed rate of the charges of alternative fuels, and a feed rate of process gases; and
(d) burning fuels,
and wherein
the gases drawn off from the reactor are one or more of:
at least partially recirculated into the reactor;
at least partially supplied to a precalcining stage of the clinker kiln; and
at least partially supplied to a preheating stage of the clinker kiln.

7. A method according to claim 6, wherein the temperatures are set and maintained to stabilize the temperature distribution within the reactor by controlling the supply of water, and wherein said water is contaminated water.

8. A method according to claim 7, wherein the contaminated water is contaminated with at least one of oil and hydrocarbons.

9. A method according to claim 6, wherein the charges of alternative fuels contained in the reactor are mechanically moved.

10. A method according to claim 6, wherein the charges of alternative fuels contained in the reactor are circulated by rotation of the reactor.

11. A method according to claim 6, wherein the charges of alternative fuels comprise at least one of carbon-carrier-contaminated earths, soils, rocks and minerals having low calorific values.

12. A method according to claim 6, wherein the charges of alternative fuels are discharged at a temperature of about 800° C.

13. A method according to claim 6, wherein the gases are drawn off at a temperature between 700° C. and 900° C.

14. A method according to claim 6, wherein the process gases comprise tertiary air.

15. A method according to claim 8, wherein the charges of alternative fuels contained in the reactor are mechanically moved.

16. A method according to claim 8, wherein the charges of alternative fuels contained in the reactor are circulated by rotation of the reactor.

17. A method according to claim 9, wherein the charges of alternative fuels contained in the reactor are circulated by rotation of the reactor.

18. A method according to claim 7, wherein the charges of alternative fuels comprise at least one of carbon-carrier-contaminated earths, soils, rocks and minerals having low calorific values.

19. A method according to claim 8, wherein the charges of alternative fuels comprise at least one of carbon-carrier-contaminated earths, soils, rocks and minerals having low calorific values.

20. A method according to claim 9, wherein the charges of alternative fuels comprise at least one of carbon-carrier-contaminated earths, soils, rocks and minerals having low calorific values.

21. A method according to claim 10, wherein the charges of alternative fuels comprise at least one of carbon-carrier-contaminated earths, soils, rocks and minerals having low calorific values.

22. A method according to claim 8, wherein the charges of alternative fuels are discharged at a temperature of about 800° C.

23. A method according to claim 10, wherein the charges of alternative fuels are discharged at a temperature of about 800° C.

24. A method according to claim 11, wherein the charges of alternative fuels are discharged at a temperature of about 800° C.

25. A method according to claim 6, wherein
the temperatures are set and maintained to stabilize the temperature distribution within the reactor by controlling the supply of water, and said water is contaminated with at least one of oil and hydrocarbons,
the charges of alternative fuels contained in the reactor are circulated by rotation of the reactor,
the charges of alternative fuels comprise at least one of carbon-carrier-contaminated earths, soils, rocks and minerals having low calorific values, and
the process gases comprise tertiary air.
